(19) United States
(12) Patent Application Publication
(10) Pub. No.: US 2004/0021937 A1
(43) Pub. Date: Feb. 5, 2004

(54) Objective with illumination

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 10/628,671

(22) Filed: Jul. 28, 2003

(30) Foreign Application Priority Data
Aug. 3, 2002 (DE) 102 35 706.4

(51) Int. Cl. G02B 21/00

(52) U.S. Cl. 359/368

(57) ABSTRACT

The invention concerns an objective with illumination, in particular for application in a stereo surgical microscope, having a multi-part objective (8), used as the main objective, that is separated into one objective part (10a) for observation and a second objective part (10b) for illumination, the objective part (10b) for illumination being removed from the objective (8) and arranged along an illumination axis (2) at an angle to the optical axis (1) of the objective (8).

### CROSS REFERENCE TO RELATED APPLICATIONS

This application claims priority of the German patent application 102 35 706.4 filed Aug. 3, 2002 which is incorporated by reference herein.

### FIELD OF THE INVENTION

The invention concerns an objective with illumination, in particular for use as the main objective in a stereo surgical microscope or in other optical instruments.

### BACKGROUND OF THE INVENTION

In conventional surgical microscopes having a main objective, a zoom, a tube with eyepieces, and a built-in illumination system for a subject field, coupling of the illumination into the main beam path of the microscope is usually accomplished between the main objective and the zoom by means of a deflection element, for example a prism (see FIG. 2). The main objective is usually a high-quality optical system, constructed from several lens element groups, that becomes increasingly complex because increasingly high imaging performance is demanded and because a trend exists toward displaceable lens element groups for focal length modification.

Because the illumination beam bundles are coupled in above the main objective, they correspondingly transilluminate the illumination aperture of all the lens element groups of the main objective. This can result in undesired reflections at the surfaces of the individual optical elements of the main objective (lens element groups), which are reflected into the observation beam path.

Methods for the reduction of undesired reflections of the illumination beam bundles into the observation beam path in the main objective are also described in documents DE-A1-195 23 712, DE-A1-197 39 428, DE-A1-29 32 486, and DE-A1-34 27 592, among others. The following possibilities are known therefrom:

Dividing the objective and using a separating cover panel;

An opening in the main objective with additional swing-in optical elements;

Individual optical elements, separate from the observation beam path, for illumination.

It is characteristic of these known approaches, analogously to the standard approach described above, that the illumination beam bundle is coupled in above the main objective, which usually comprises several lens element groups.

The inventor has recognized that these systems are disadvantageous in terms of the following points:

The trend toward complex main objectives, sometimes equipped with variable focal length, results in a large number of lens elements groups (and therefore interfaces) in the main objective, with the result that troublesome reflections travel by way of the illumination beam bundles into the observation beam path and thus cause a degradation in image quality.

The fact that the illumination beam bundles are reflected in above the main objective results in an undesirably large overall height.

The approaches disclosed in the documents cited above are complex in terms of optical and mechanical alignment, and require additional optical elements that differ greatly from the main objective.

### SUMMARY OF THE INVENTION

It is therefore the object of the invention to create an objective with illumination, in particular as the main objective for surgical microscopes, which from the standpoints of high image quality and, in particular, low overall height, ensure the greatest possible freedom from reflections in the observation beam path.

This object is achieved by an objective comprising an optical axis; a first objective part for observation; and a second objective part for illumination separated from the first objective part and having an illumination axis at an angle to the optical axis of the objective. In one embodiment, a deflection element is mounted directly above a front lens element group of the objective for coupling an illumination beam path into a beam path of the microscope. In another embodiment, the front lens element group is separated into two decoupled parts, one for illumination and one for observation, and the deflection element is arranged so its exit surface is coplanar with an exit surface of the observation part of the front lens element group.

In a further embodiment of the invention, the first objective part includes optical elements displaceable along the optical axis of the objective and the second objective part includes optical elements displaceable along the illumination axis and correlated to the displaceable optical elements of the first objective part, whereby a change in position of the displaceable optical elements of the first objective part results in a change in position of the correlated displaceable optical elements of the second objective part.

In another optional aspect of the invention, the front lens element group is divided into an illumination part and an observation part by an optical decoupling means, for example by an opaque cover between the parts.

### BRIEF DESCRIPTION OF THE DRAWINGS

The invention will be explained in further detail below with reference to Figures in which, in a schematic presentation:

FIG. 1 shows the construction of an objective having an illumination incoupling system according to the present invention;

FIG. 1A shows the division of the front lens element group of the objective into the front lens element group parts for observation and for illumination, respectively;

FIG. 2 shows the construction of a conventional illumination incoupling system above the main objective;

FIGS. 3A through 3C show variants of the deflection element with variously curved deflection surfaces and entrance and exit surfaces;

FIG. 4 shows a variant of the illumination incoupling system according to the present invention having a deflection element that is arranged in the plane of the front lens element group for illumination; and

FIG. 5 shows the front lens element group parts optically decoupled by means of a cover.

### DETAILED DESCRIPTION OF THE INVENTION

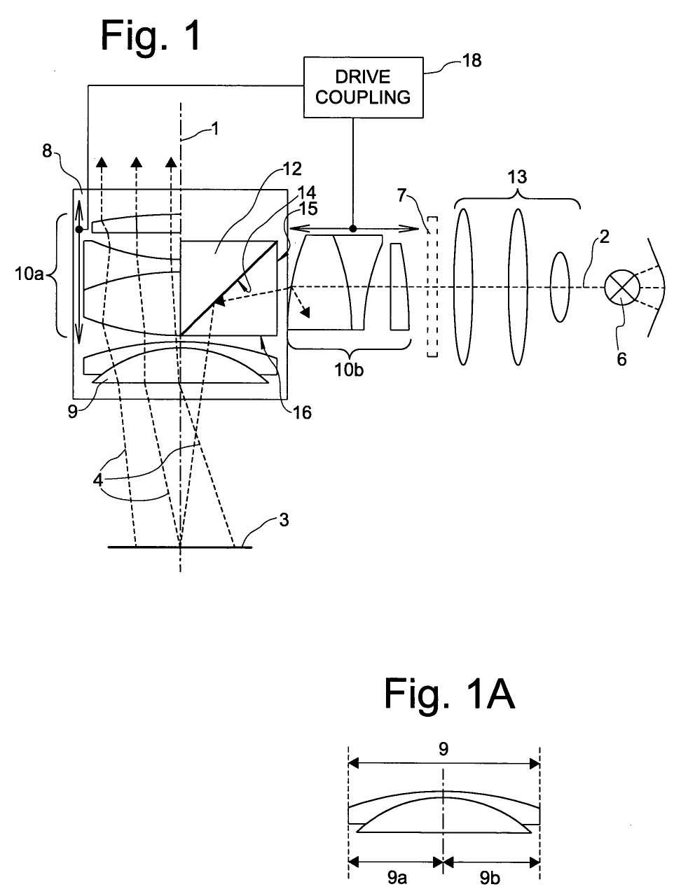

FIG. 1 shows the construction of an objective 8 having an illumination incoupling system according to the present invention, depicting an optical axis 1 of objective 8, an illumination beam path 2, a subject field 3, a front lens element group 9 of objective 8, an objective part 10a for observation, an objective part 10b for illumination, a deflection element 12 for illumination having a deflection surface 14 as well as entrance and exit surfaces 15 and 16, an illumination optical system 13, a light source 6 with a reflector, and (symbolically) a stop/display 7.

Light generated by light source 6 is directed via illumination optical system 13 onto objective part 10b for illumination onto deflection element 12, for example a mirror or prism. Deflection element 12 encompasses a deflection surface 14, an entrance surface 15, and an exit surface 16. Light deflected by deflection element 12 is directed through front lens element group 9 of objective 8 onto subject field 3. Light reflected at subject field 3 is guided, as observation beam path 4, via front lens element group 9 of objective 8 onto objective part 10a for observation, and directed from there onto the downstream optical elements (not depicted) of the microscope, such as the zoom, tube, and eyepiece.

It is evident from FIG. 1 that illumination beam path 2 is guided strictly separately from observation beam path 4, so that undesired reflections 5 from illumination beam path 2 into observation beam path 4 are prevented. It is further evident that objective part 10b for illumination corresponds to the detached objective part 10a for observation. The result is that identical image quality is achieved for illumination and for observation.

FIG. 1A shows the division of front lens element group 9 into front lens element group parts 9a for observation and 9b for illumination.

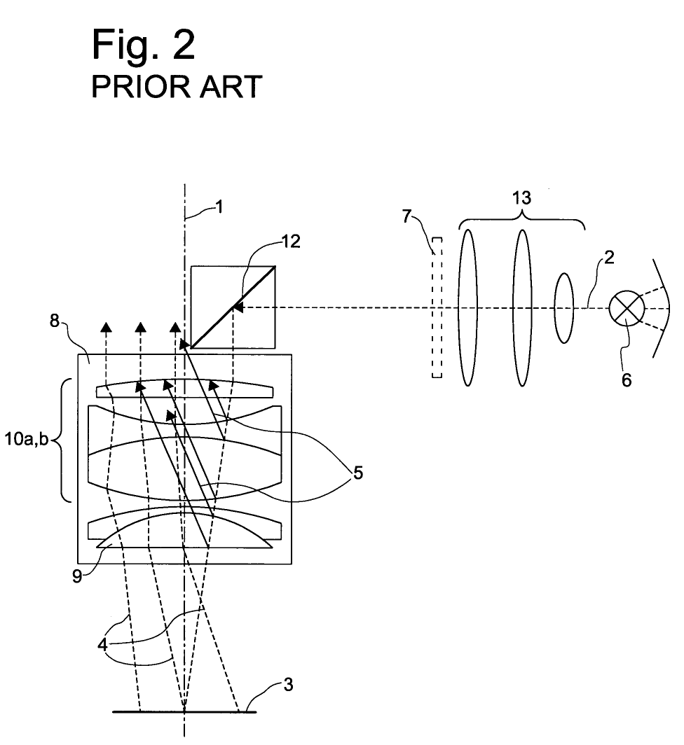

FIG. 2 shows, by analogy with FIG. 1, the construction of a conventional illumination incoupling system in which illumination beam path 2 is directed into objective 8 via a deflection element 12 placed above objective 8. The illumination causes reflections 5 at the various lens element groups in objective 8, which get into observation beam path 4 and degrade it.

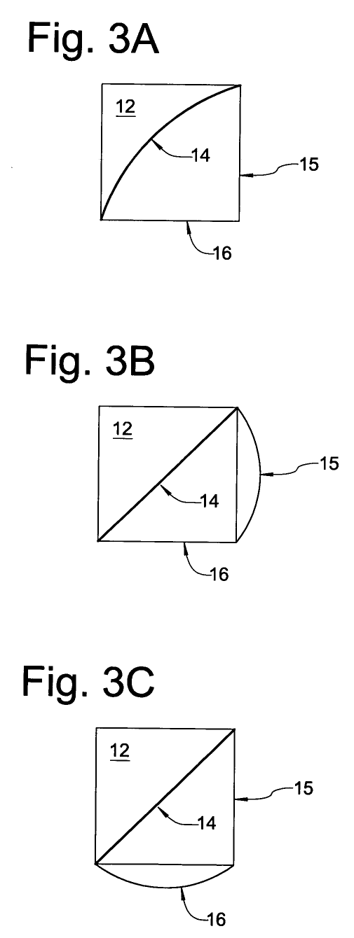

FIGS. 3A through 3C show variants of deflection element 12 with various curvatures of deflection surface 14 and of entrance and exit surfaces 15 and 16, respectively. By means of these surfaces 14, 15, 16 of, for example, concave or convex curvature, different optical properties (focal lengths) of the deflection element are achieved.

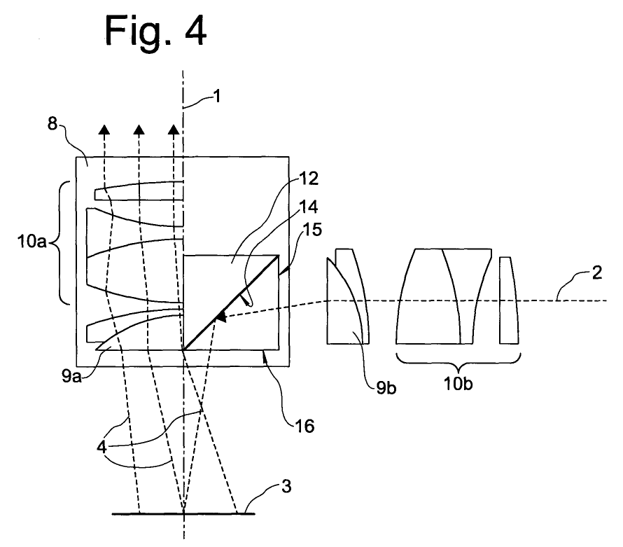

FIG. 4 shows a variant of the illumination incoupling system according to the present invention having a differently arranged deflection element 12. Here front lens element group part 9b for illumination is removed from objective 8 and, instead of it, deflection element 12 is inserted on the same plane as front lens element group part 9a for illumination. In order to achieve an illumination optical system unchanged from the one according to the present invention, front lens element part 9b for illumination is inserted into illumination beam path 2 outside objective 8.

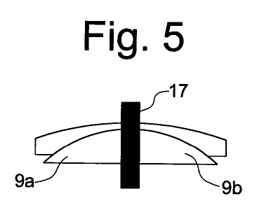

FIG. 5 shows front lens element group parts 9a and 9b optically decoupled by means of a cover 17. A cover is inserted between front lens element group part 9a for observation and front lens element group part 9b for illumination.

Objective 8, which is assembled from several lens element groups and whose portion facing toward subject field 3 constitutes front lens element group 9 of objective 8, is (with the exception of said front lens element group 9) separated into two parts of arbitrary shape. The one part is used for observation beam path 4, the other part for illumination beam path 2. Objective part 10a for observation remains in its accustomed location; objective part 10b for illumination is removed from the original objective system and associated with light source 6 with reflector (illumination system). The axis of this objective part 10b for illumination is then, for example, perpendicular to optical axis 1 of the originally undivided objective 8.

In order to recombine observation beam path 4 and illumination beam path 2, a deflection element 12 (for example a prism or mirror) is inserted at the point at which objective part 10b for illumination previously was.

Observation beam path 4 thus also continues to be directed through the unmodified objective part 10a for observation. According to the present invention, illumination beam path 2 is coupled in directly via front lens element group 9. The detached objective part 10b for illumination, although it is arranged e.g. perpendicular to optical axis 1 of the original objective 8, is used as before in order to image subject field 3. The complex configuration of the detached objective part 10b for illumination thus results in correspondingly good correction of illumination beam path 2. Note in this context that the now-increased air gap and the path in glass in deflection element 12 should be incorporated into the correction of illumination beam path 2, either as a modified correction of objective part 10b for illumination or in terms of the selection of illumination optical system 13, which is still additionally required.

According to a development of the invention, axially and radially displaceable stops and/or displays 7 can additionally be incorporated into illumination optical system 13.

As a development of the invention, displaceable lens element groups can also be used in objective part 10b for illumination, corresponding to the design of the original objective 8.

The improvements achieved by way of the illumination incoupling system according to the present invention described above are as follows:

Lower overall height as compared to conventional systems;

Improved optical imaging quality of the illumination as compared to previous simpler illumination systems;

Improved optical imaging quality of stops and/or displays that are incorporated into the illumination beam path;

Reflections from the surfaces of objective lenses in the illumination beam path no longer get into the observation beam path, since the observation beam path and illumination beam path are guided strictly separately from one another;

Simplified production of the optical elements of the illumination optical system, if optical elements identical to those in the observation beam path are used;

Additional prisms or deflection elements for alignment of the illuminated field are no longer necessary;

Optimum termination of the microscope system due to retention of the shared front lens element group of the main objective.

Application of the invention is not limited to stereomicroscopes; it can be utilized both in simpler microscopes or in comparable devices with illumination through an objective.

Parts List

1 Optical axis of (8)

2 Illumination beam path

3 Subject field

4 Observation beam path

5 Reflection(s) in (4)

6 Light source with reflector

7 Stop/display

8 Objective

9 Front lens element group of (8)

9a Front lens element group part for observation

9b Front lens element group part for illumination

10a Objective part for observation

10b Objective part for illumination

12 Deflection element

13 Illumination optical system

14 Deflection surface of (12)

15 Entrance surface of (12)

16 Exit surface of (12)

17 Cover

What is claimed is:

1. An objective for a microscope, the objective comprising:
an optical axis;
a first objective part for observation; and
a second objective part for illumination, the second objective part being separated from the first objective part and having an illumination axis at an angle to the optical axis of the objective.

2. The objective as defined in claim 1, further comprising a front lens element group and a deflection element mounted directly above the front lens element group for coupling an illumination beam path into a beam path of the microscope.

3. The objective as defined in claim 2, wherein the deflection element includes an entrance surface, a deflection surface, and an exit surface, and at least one of the entrance, deflection and exit surfaces is a convexly curved surface.

4. The objective as defined in claim 2, wherein the deflection element includes an entrance surface, a deflection surface, and an exit surface, and at least one of the entrance, deflection and exit surfaces is a concavely curved surface.

5. The objective as defined in claim 1, wherein deviations in the optical correction between the a first objective part for observation and the second objective part for illumination are corrected at least in part by way of modified air gaps.

6. The objective as defined in claim 2, wherein deviations in the optical correction between the a first objective part for observation and the second objective part for illumination are corrected at least in part by way of modified paths in glass of the deflection element.

7. The objective as defined in claim 1, wherein the first objective part includes optical elements displaceable along the optical axis of the objective and the second objective part includes optical elements displaceable along the illumination axis and correlated to the displaceable optical elements of the first objective part, and wherein a change in position of the displaceable optical elements of the first objective part results in a change in position of the correlated displaceable optical elements of the second objective part.

8. The objective as defined in claim 7, wherein the displaceable optical elements of the first objective part are mechanically coupled to the displaceable optical elements of the second objective part.

9. The objective as defined in claim 7, wherein the displaceable optical elements of the first objective part are electro-mechanically coupled to the displaceable optical elements of the second objective part.

10. The objective as defined in claim 1, further comprising a front lens element group having a first front lens element group part on an observation beam path and a second front lens element group part on an illumination beam path, and means for optically decoupling the second front lens element group from the observation beam path.

11. The objective as defined in claim 10, wherein the means for optically decoupling the second front lens element group from the observation beam path includes a cover.

12. The objective as defined in claim 10, wherein the second front lens element group part is associated with the second objective part, and the objective further comprises a deflection element arranged such that an exit surface of the deflection element is coplanar with a surface of the first front lens element group part.

13. The objective as defined in claim 1, wherein the separation of the first and second objective parts deviates from bisection.
